(19) United States
(12) Patent Application Publication
(10) Pub. No.: US 2008/0072731 A1
(43) Pub. Date: Mar. 27, 2008

(54) Circular saw blade

(76) Inventor: Ing Johannes Troger, Stuttgart (DE)

Correspondence Address: KLAUS J. BACH, 4407 TWIN OAKS DRIVE, MURRYSVILLE, PA, 15668, US

(21) Appl. No.: 11/901,938

(22) Filed: Sep. 19, 2007

(30) Foreign Application Priority Data
Sep. 21, 2006 (DE) 20 2006 014 526.5

(51) Int. Cl. B26D 1/12

(52) U.S. Cl. 83/676

(57) ABSTRACT

In a circular saw blade which includes expansion and vibration damping slots, the slots have parallel side walls with an inclination with respect to the circular saw surface which inclination changes over the length of the slots.

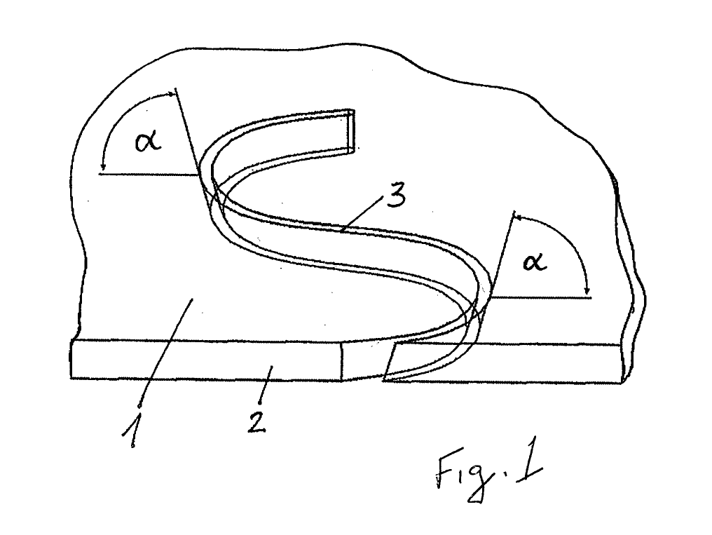

### BACKGROUND OF THE INVENTION

The invention resides in a circular saw blade with vibration damping and expansion slots.

Saw blades, specifically circular saw blades provided with hard metal or diamond teeth, are generally known and widely used. The saw blade disc consists of a tool steel provided with teeth. Since the thickness of the saw blade is small in comparison with the circular saw blade disc diameter, the circular discs are capable of vibrating similar to a chime and capable of vibrating in many ways at various characteristic frequencies.

These vibrations of the circular disc affect the cutting quality of the saw blade in a particularly disadvantageous way. In order to avoid the detrimental effects caused by those vibrations the circular saw blade discs are provided with radial slots which are partially filled with various plastic materials. However, these plastic fillings are generally soon loosened by the movement of the slot walls which generally vibrate in opposite direction and are then released.

With the slots formed into the saw blade, the saw blade loses a good part its vibration tendencies similar to a cracked ceramic cup but, unfortunately, also a substantial part of its static rigidity, that is, the saw blade becomes more bendable and, during cutting, has a reduced guide stability. The teeth disposed adjacent the slots vibrate in opposition to the adjacent saw blade sections whereby the cutting line error may be increased and the cutting quality is reduced.

The slots are provided in praxis in many forms and are subject of numerous patents. The slots may not extend all the way to the circumferential edge of the tool as it is shown for example in EP-0 640 422 A1 which discloses a disc body with slots which are arranged side-by-side in circumferential direction but which all end before the circumferential edge of the disc body. However, the slots may also be open at the circumference of the disc as it is known for example from EP 0 239 676 A1 where the tool is provided with several radially inwardly extending slots which may be wave-shaped and circumferentially displaced and which, furthermore, are disposed in the radially inner part of the tool and end at a distance from the outer edge of the tool.

EP 0 243 909 B1 discloses a tool body of a circular saw blade which, at its circumference, is provided with tangentially extending slots and, additionally, with radially extending slots, wherein the radially and tangentially extending slots may merge and the radial slots may extend up to the circumferential edge of the tool body. It is furthermore known from this document to clamp the areas separated by the radial slots together by a spring clamp which can be welded, soldered or riveted to the tool body. A similar proposal is offered in EP 0 303 770 B1 where the tool disc is provided with short slots extending radially up to the tool edge and which, at their inner ends are provided with a bore into which a rivet is pounded which is intended to dampen noise. In addition, in the radially inner area of the saw blade thin radial slot may be provided in various positions which do not extend to the circumference.

In spite of the many attempts at solutions as they have been disclosed shortly a satisfying solution has yet to be provided.

It is therefore the object of the present invention to provide an arrangement which compensates to some extent for the loss of the static rigidity resulting from the provision of the slots and, at the same time, improves the damping in comparison with the conventional slot arrangements.

### SUMMARY OF THE INVENTION

In a circular saw blade which includes expansion and vibration damping slots, the slots have parallel side walls with an inclination with respect to the circular saw surface which inclination changes over the length of the slots.

The form of the slots, that is the course of the slots, may vary that is the slots are straight, curved or curved in opposite directions (wave-like), or partially circular and extend in radial and/or tangential direction in the plane of the saw blade. Basically, in accordance with the invention, the walls of the slots formed into the saw blade do not extend normal to the surface of the blade but form with the saw blade plane an angle which changes over the length of the slots such that the angle changes its size and also changes between negative and positive orientations.

In a particular embodiment of the invention, the slots provided with the geometry according to the invention can again be filled with a vibration damping material which is substantially softer than the tool steel of which the tool body consists. Because of the slot geometry, this material is no longer subjected mainly to shear forces but mainly to compression forces. With the changing slot wall angles α, the vibration movements of the slot surfaces in opposite directions is prevented so that the vibration damping material is no longer destroyed or pressed or moved out of the slots. The soft and vibration-damping material disposed in the slots, which material consists of a suitable plastic material or a soft metal such as soldering tin, does not only provide for improved vibration damping of saw blades in comparison with blades with non-filled slots but also substantially improves the static rigidity which may even equal that of a blade without slots.

Because of the changing angles of the slot walls, the saw blade elements do no longer bend or vibrate sidewardly but, if at all the whole blade bends outwardly. As a result, the saw blade according to the invention acts as far as its static rigidity is concerned practically like a blade without any slots.

An embodiment of the invention will be described below on the basis of the accompanying drawing:

### BRIEF DESCRIPTION OF THE DRAWING

The sole FIGURE is a perspective view of a saw blade section with a curved groove having inclined sidewalls in accordance with the invention.

### DESCRIPTION OF THE PREFERRED EMBODIMENT

The FIGURE shows a saw blade section as seen at an angle from the top. Only a small area of the circumference of a circular saw blade tool body 1 is shown which includes a slot 3 which extends from the circumference 2 radially and wave-like inwardly and which has parallel slot walls.

Although opposite slot walls extend parallel, the angle of the slot walls relative to the surface of the saw blade changes over the length of the slots. The size of the angle as well as the orientation of the angle change between a positive and a negative orientation. The angle is designated with α. In the FIGURE, the angle α is marked twice that is one time at the right near the termination of the slot of the circumference 2 of the saw blade and also further to the left near a radially inwardly arranged section of the slot shown in the upper part of the drawing. As apparent from the drawing, the two angles α have opposite orientations (+ and −) that is the slot walls are tilted with respect to the surface of the tool body one to the right and the other to the left.

What is claimed is:

1. A circular saw blade (1) including expansion and vibration damping slots (3), said slots (3) having side walls with an inclination (α) with respect to the circular saw surface which inclination changes over the length of the slots.

2. A circular saw blade (1) according to claim 1, wherein the inclination angle (α) changes along the slot length with respect to the size as well at the inclination direction (+ and −) of the slot side walls and the blade surface.

3. A circular saw blade (1) according to claim 1, wherein at least one of the slots (3) is filled with a vibration damping material.
